(19) United States
(12) Patent Application Publication
(10) Pub. No.: US 2024/0379936 A1
(43) Pub. Date: Nov. 14, 2024

(54) ELECTRODE RECYCLING VIA RAPID, HIGH-TEMPERATURE HEATING

(71) Applicants: UNIVERSITY OF MARYLAND, COLLEGE PARK, College Park, MD (US); VIRGINIA TECH INTELLECTUAL PROPERTIES, INC., Blacksburg, VA (US)

(72) Inventors: Liangbing HU, Rockville, MD (US); Xizheng WANG, Greenbelt, MD (US); Tangyuan LI, College Park, MD (US); Feng LIN, Christianburg, VA (US); Lei TAO, Blacksburg, VA (US)

(21) Appl. No.: 18/660,510

(22) Filed: May 10, 2024

Related U.S. Application Data
(60) Provisional application No. 63/501,390, filed on May 10, 2023.

(51) Int. Cl. H01M 4/04; B09B 3/40; B09B 101/16

(52) U.S. Cl. CPC H01M 4/0471; B09B 3/40; B09B 2101/16

(57) ABSTRACT

Degraded electrode material from a used battery can be recycled by subjecting to a thermal shock. The degraded electrode material can have impurities resulting from charge/discharge cycling of the battery. The thermal shock can have a temperature of at least 1000 K for a time period of 10 seconds or less, for example, less than or equal to 1 second. The thermal shock can also include a heating rate of at least 10³ K/second preceding the time period and a cooling rate of at least 10³ K/second following the time period. The subjecting to the thermal shock regenerate the electrode material, for example, by removing impurities from the electrode material and/or replenishing metal ions within the electrode material.

### CROSS-REFERENCE TO RELATED APPLICATION(S)

The present application claims the benefit of U.S. Provisional Application No. 63/501,390, filed May 10, 2023, entitled “Battery Electrode Recycling via Rapid High-Temperature Heating,” which is hereby incorporated by reference herein in its entirety.

### STATEMENT REGARDING PRIOR DISCLOSURE

Pursuant to 35 U.S.C. § 102 (b) (1) (A), “Direct and Rapid High-Temperature Upcycling of Degraded Graphite” by the instant inventors was published as paper 2302951 in volume 33 of the journal Advanced Functional Materials on Jun. 27, 2023.

### FIELD

The present disclosure relates generally to processing and/or manufacturing of electrodes, and more particularly, to recycling of electrodes, for example, depleted and/or degraded electrodes from a used battery.

### BACKGROUND

Existing techniques for recycling used battery components, such as hydrometallurgical and pyrometallurgical processes, primarily recover metals (e.g., Li, Co, Ni, Mn, etc.) from positive electrodes (e.g., cathode), while materials (e.g., graphite) from the negative electrodes (e.g., anode) are either burned or disposed (e.g., landfill). In order to recycle electrodes for reuse, impurities (e.g., solid electrolyte interphase (SEI), binder, solvent, etc.) that formed in and/or on the electrodes by charge/discharge cycling of the battery should be removed. While laboratory scale processes for recycling degraded graphite from negative electrodes have been proposed, such processes may suffer from low efficiency and/or may not eliminate complex organic or inorganic impurities. Embodiments of the disclosed subject matter may address one or more of the above-noted problems and disadvantages, among other things.

### SUMMARY

Embodiments of the disclosed subject matter provide recycled electrodes, as well as methods and systems for recycling depleted and/or degraded electrodes, for example, from used batteries. In some embodiments, the recycling involves subjecting electrode material (e.g., disassembled or otherwise extracted from a used battery) to a high-temperature, short-duration thermal shock. In some embodiments, the thermal shock is effective to remove impurities from the electrode material, such that the electrode material can be reused in another battery. In some embodiments, the removed impurities can include solid electrolyte interphase (SEI), binder, residue solvent, and/or isolated metal (e.g., from the positive electrode). Alternatively or additionally, in some embodiments, the thermal shock is effective to introduce metal into the electrode material, so as to regenerate the electrode material for use in a cathode. In some embodiments, the thermal shock can be applied to a degraded full sheet electrode or degraded electrode material extracted from an electrode.

In one or more embodiments, a method can comprise subjecting degraded electrode material of a negative electrode from a battery to a thermal shock. The degraded electrode material can have impurities resulting from charge/discharge cycling of the battery. The thermal shock can comprise a temperature of at least 1000 K for a time period of 10 seconds or less, a heating rate of at least 10³ K/second preceding the time period, and a cooling rate of at least 10³ K/second following the time period. The subjecting to first thermal shock can remove at least some impurities from the degraded electrode material so as to form a regenerated electrode material.

In one or more embodiments, a method can comprise providing particles on degraded electrode material of a positive electrode from a battery. The particles can comprise a metal. The degraded electrode material can be depleted of the metal by charge/discharge cycling of the battery and/or can have impurities resulting from the charge/discharge cycling of the battery. The method can further comprise subjecting the degraded electrode material with particles thereon to a thermal shock. The thermal shock can comprises a temperature of at least 1000 K for a time period of 10 seconds or less, a heating rate of at least 10³ K/second preceding the time period, and a cooling rate of at least 10³ K/second following the time period. The subjecting to the thermal shock can at least partially replenish the first metal within the degraded electrode material and/or remove at least some impurities from the degraded electrode material, so as to form a regenerated electrode material.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a process flow diagram of a generalized method for electrode material recycling, according to one or more embodiments of the disclosed subject matter.

FIG. 1B is a graph depicting aspects of an exemplary thermal shock profile that can be employed for electrode material recycling, according to one or more embodiments of the disclosed subject matter.

FIG. 1C is a simplified schematic diagram illustrating certain structural features of a battery for recycling, according to one or more embodiments of the disclosed subject matter.

FIG. 2A is a simplified schematic diagram illustrating aspects of recycling of an electrode particle via a thermal shock, according to one or more embodiments of the disclosed subject matter.

FIG. 2B is a simplified schematic diagram illustrating aspects of coating of a negative electrode particle via a thermal shock, according to one or more embodiments of the disclosed subject matter.

FIG. 2C is a simplified schematic diagram illustrating aspects of regenerating a positive electrode particle via a thermal shock, according to one or more embodiments of the disclosed subject matter.

FIG. 2D is a simplified schematic diagram illustrating aspects of recycling of a full sheet electrode via a thermal shock, according to one or more embodiments of the disclosed subject matter.

FIG. 3A is a simplified schematic diagram of a setup employing a single Joule heating element for recycling electrode material via a thermal shock, according to one or more embodiments of the disclosed subject matter.

FIG. 3B is a simplified schematic diagram of another setup employing two Joule heating elements for recycling electrode material via a thermal shock, according to one or more embodiments of the disclosed subject matter.

FIG. 3C is a simplified schematic diagram of another setup employing two Joule heating elements for recycling electrode material via a thermal shock, according to one or more embodiments of the disclosed subject matter.

FIG. 3D is a simplified schematic diagram of another setup employing Joule heating elements for recycling electrode material via a thermal shock, according to one or more embodiments of the disclosed subject matter.

FIG. 4A is a simplified schematic diagram of a setup employing a single Joule heating element for recycling electrode material powder via a thermal shock, according to one or more embodiments of the disclosed subject matter.

FIG. 4B is a simplified perspective diagram of another setup employing Joule heating elements for recycling electrode material powder via a thermal shock, according to one or more embodiments of the disclosed subject matter.

FIG. 4C is a simplified perspective diagram of another setup employing gravity-directed particle flow between a pair of Joule heating elements for recycling electrode material powder via a thermal shock, according to one or more embodiments of the disclosed subject matter.

FIG. 4D is a simplified schematic diagram of another setup employing gravity-assisted particle flow along an angled Joule heating element for recycling electrode material powder via a thermal shock, according to one or more embodiments of the disclosed subject matter.

FIGS. 5A-5B are simplified schematic diagrams illustrating aspects of first and second stages, respectively, in concurrent recycling of positive and negative electrode materials, according to one or more embodiments of the disclosed subject matter.

FIG. 6A is a simplified schematic diagram of a battery recycling system, according to one or more embodiments of the disclosed subject matter.

FIG. 6B depicts a generalized example of a computing environment in which the disclosed technologies may be implemented.

FIGS. 7A1-7A2 show images of a degraded graphite full sheet electrode and a recycled graphite full sheet electrode after a thermal shock (1200 K, 200 ms), respectively.

FIGS. 7B1-7B2 show scanning electron microscopy (SEM) images of surfaces of the degraded graphite full sheet electrode and the recycled graphite full sheet electrode, respectively.

FIGS. 7C1-7C2 show SEM images of cross-sections of the degraded graphite full sheet electrode and the recycled graphite full sheet electrode, respectively.

FIGS. 8A-8B are X-ray diffraction (XRD) patterns of a degraded graphite full sheet electrode and a recycled graphite full sheet electrode after a thermal shock (1200 K, 200 ms), respectively.

FIGS. 9A-9B illustrate long-term cycling performance of a cell with degraded graphite electrode (without thermal shock) and lithium (DGIILi cell) at 0.2 C and corresponding voltage profiles at different cycles, respectively.

FIGS. 9C-9D illustrate long-term cycling performance of a cell with recycled graphite electrode (thermal shock, 1200 K, 200 ms) and lithium (RG∥Li cell) at 0.2 C and corresponding voltage profiles at different cycles, respectively.

FIG. 10 illustrates results of thermal shocks of durations of 200 ms and 1 s on degraded graphite electrodes.

FIG. 11A shows an SEM image and corresponding elemental mapping for a degraded graphite electrode.

FIG. 11B shows the elemental contents of the degraded graphite electrode.

FIG. 11C shows an SEM image and corresponding elemental mapping for a recycled graphite electrode.

FIG. 11D shows the elemental contents of the recycled graphite electrode.

FIG. 12 compares XRD patterns for pristine graphite, degraded graphite, and recycled graphite.

FIGS. 13A and 13C illustrates capacity density and coulombic efficiency of a lithium ion battery fabricated using a recycled graphite anode at 0.2 C and 1 C, respectively.

FIGS. 13B and 13D illustrates voltage as a function of specific capacity for a lithium ion battery fabricated using a recycled graphite anode at 0.2 C and 1 C, respectively.

FIGS. 14A-14B show transmission electron microscopy (TEM) images for regenerated graphite power subjected to thermal shocks of 1600 K for 1 s and 1800 K for 1 s, respectively.

FIG. 15 shows TEM images for another regenerated graphite powder subject to a thermal shock of 2000 K for 1 s.

### DETAILED DESCRIPTION

### General Considerations

For purposes of this description, certain aspects, advantages, and novel features of the embodiments of this disclosure are described herein. The disclosure should not be construed as being limiting in any way. Instead, the present disclosure is directed toward all novel and nonobvious features and aspects of the various disclosed embodiments, alone and in various combinations and sub-combinations with one another. The disclosed embodiments are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated examples. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of examples of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following are provided to facilitate the description of various aspects of the disclosed subject matter and to guide those skilled in the art in the practice of the disclosed subject matter.

Thermal shock: Application of a peak temperature for a time period having a duration less than or equal to about 10 s. In some embodiments, the duration of the time period of thermal shock is less than or equal to 1 s, for example, in a range of 100-500 ms, inclusive. In some embodiments, the thermal shock may involve heating to the peak temperature at a ramp rate of at least 10³ K/s (e.g., about 10⁵ K/s) prior to the time period, and/or cooling from the peak temperature at a ramp rate of at least 10³ K/s (e.g., about 10⁵ K/s).

Thermal shock temperature: A peak or maximum temperature at a surface of one or more heating elements when energized (e.g., by application of a current pulse) and/or at a surface of a material being processed (e.g., electrode material). In some embodiments, the thermal shock temperature is at least about 1000 K, for example, at least 1200 K or at least 1500 K. In some embodiments, the thermal shock temperature is in a range of about 1000 K to about 3000 K. In some embodiments, a temperature at the material being processed can match or substantially match (e.g., within 10%) the temperature of at least one heating element.

Powder: A plurality of particles, each having a maximum cross-sectional dimension (e.g., diameter when the particle is spherical) less than or equal to about 1 mm. In some embodiments, the powder, or a component thereof, can be considered a micropowder, e.g., having particle sizes in a range of 1-100 μm, for example, about 40-50 μm. Alternatively or additionally, the powder, or a component thereof, can be considered a nanopowder, e.g., having particles sizes in a range of 1 nm to 1 μm, for example, about 10-20 nm. In some embodiments, an identified particle size represents an average particle size for all particles (e.g., an average of the maximum cross-sectional dimensions). In some embodiments, the particle size can be measured according to one or more known standards, such as, but not limited to, ASTM B214-16 entitled “Standard Test Method for Sieve Analysis of Metal Powders,” ASTM B330-20 entitled “Standard Test Methods for Estimating Average Particle Size of Metal Powders and Related Compounds Using Air Permeability,” ASTM B822-20 entitled “Standard Test Method for Particle Size Distribution of Metal Powders and Related Compounds by Light Scattering,” and ASTM B922-20 entitled “Standard Test Method for Metal Powder Specific Surface Area by Physical Adsorption,” all of which are incorporated by reference herein.

### INTRODUCTION

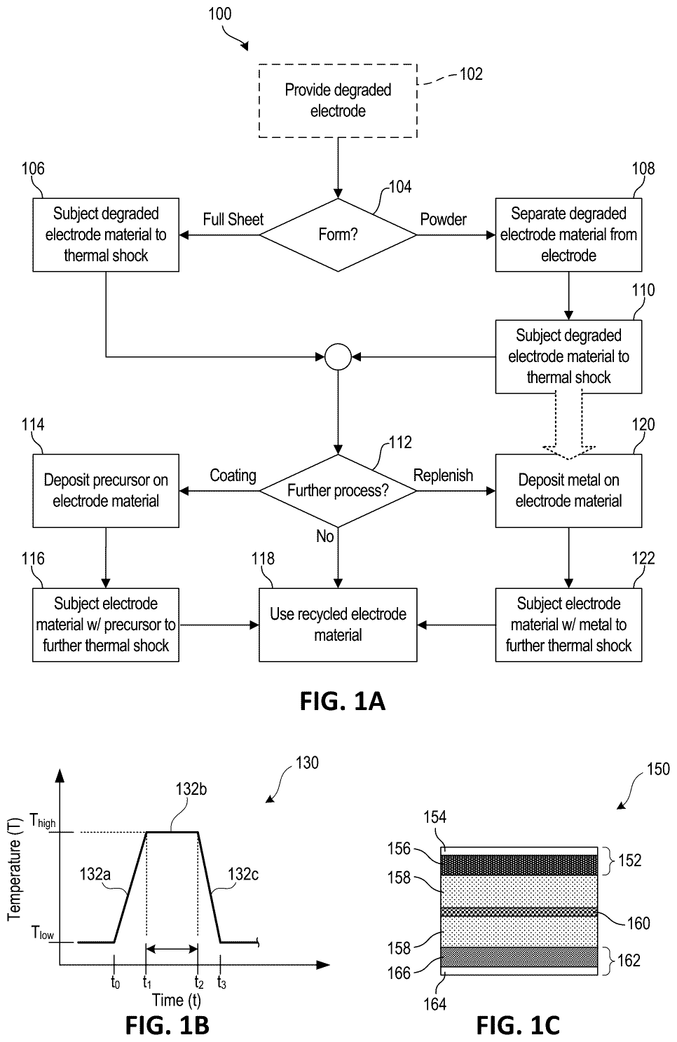

Disclosed herein are methods and systems for recycling depleted and/or degraded electrodes. In some embodiments, the recycling involves subjecting electrode material (e.g., disassembled or otherwise extracted from a used battery) to a high-temperature, short-duration thermal shock. The electrode material can be disassembled or extracted from a used battery (e.g., lithium ion battery) or other energy storage device. For example, FIG. 1C shows a battery 150 that can be subject to the disclosed recycling technique. In the illustrated example, battery 150 comprises a positive electrode 152 (e.g., cathode) separated from a negative electrode 162 (e.g., anode) by electrolyte 158 and separator 160. Positive electrode 152 can include a layer 156 of positive electrode material (e.g., lithiated transition metal oxide, etc.) coupled to a metal current collector layer 154 (e.g., copper), and negative electrode 162 can include a layer 166 of negative electrode material (e.g., graphite, tin, silicon, etc.) coupled to a metal current collector layer 164 (e.g., copper). One or both of the electrodes 152, 162 can be recycled after removal from or disassembly of the battery 150. In some embodiments, the thermal shock can be applied to the full sheet electrode 152, 162, or the electrode material separated from the respective current collector layer 154, 164 (e.g., as a powder).

In some embodiments, the thermal shock can be achieved, for example, by a pulsed heating profile 130, as shown in FIG. 1B. The pulsed heating profile 130 can initiate at relatively low temperature (e.g., <400 K, such as room temperature (e.g., 290-300 K)) and can include (i) a rapid heating ramp 132a (e.g., (T_{high}-T_{low})/(t₁-t₀)≥10³ K/s), (ii) a short dwell period 132b (e.g., (t₂-t₁)≤10 s, such as ≤1 s, for example, in a range of 100-500 ms) at or about peak temperature, T_{high} (e.g., ≥1000 K, such as ≥1200 K), and (iii) a rapid cooling ramp 132c (e.g., (T_{high}-T_{low})/(t₃-t₂) ≥10³ K/s). For example, in some embodiments, the peak temperature, T_{high}, of the dwell period 132b can in a range of 1000-3000 K, inclusive, (e.g., 1200-1500 K) for a duration of about 200 ms.

In some embodiments, the pulsed heating profile can be provided by passing electrical current through a heating element (e.g., formed or composed of carbon) to provide Joule heating. Alternatively or additionally, in some embodiments, the pulsed heating profile can be provided by a separate heating mechanism (e.g., direct Joule heating, conduction heating, radiative heating, microwave heating, laser heating, plasma heating, or any combination of the foregoing) in thermal communication with the electrode material and capable of providing the heating profile of FIG. 1B. In some embodiments, the thermal shock process can be terminated by conveying the electrode material out of a heating zone and/or by de-activating, de-energizing, or otherwise terminating operation of the heating elements. Alternatively or additionally, in some embodiments, the cooling can be achieved using one or more passive cooling features (e.g., heat sinks thermally coupled to the heating element and/or electrode material, etc.), one or more active cooling features (e.g., fluid flow directed at the electrode material and/or the heating element, fluid flow through a support member for the electrode material or a heat sink thermally coupled thereto, etc.), or any combination thereof. Further details regarding a thermal shock process, which can be employed in embodiments of the disclosed subject matter, can be found in U.S. Publication No. 2019/0161840, published May 30, 2019, which details are incorporated by reference herein.

In some embodiments, the thermal shock is effective to remove impurities from the electrode material, such that the electrode material can be reused in another battery. In some embodiments, the removed impurities can include solid electrolyte interphase (SEI), binder, residue solvent, and/or isolated metal (e.g., alkali metal from the positive electrode). In some embodiments, the recycled electrode material can exhibit the same or better battery performance (e.g., reversible capacity) as the pristine electrode material (e.g., prior to any use). Alternatively or additionally, in some embodiments, the thermal shock is effective to introduce metal (e.g., lithium) into the electrode material, so as to regenerate the electrode material for use in a positive electrode.

### Electrode Recycling Method Examples

FIG. 1A illustrates a method 100 for recycling depleted and/or degraded electrode material from used batteries. The method 100 can initiate at optional process block 102, where one or more electrodes can be provided. For example, the providing of process block 102 can include disassembling one or more used batteries and separating the positive and negative electrodes therefrom. In some embodiments, the negative electrode(s) from the one or more used batteries can be separated from the positive electrode(s) for separate processing. Alternatively, in some embodiments, the providing of process block 102 can include providing electrode(s) that have already been separated or disassembled from the one or more batteries.

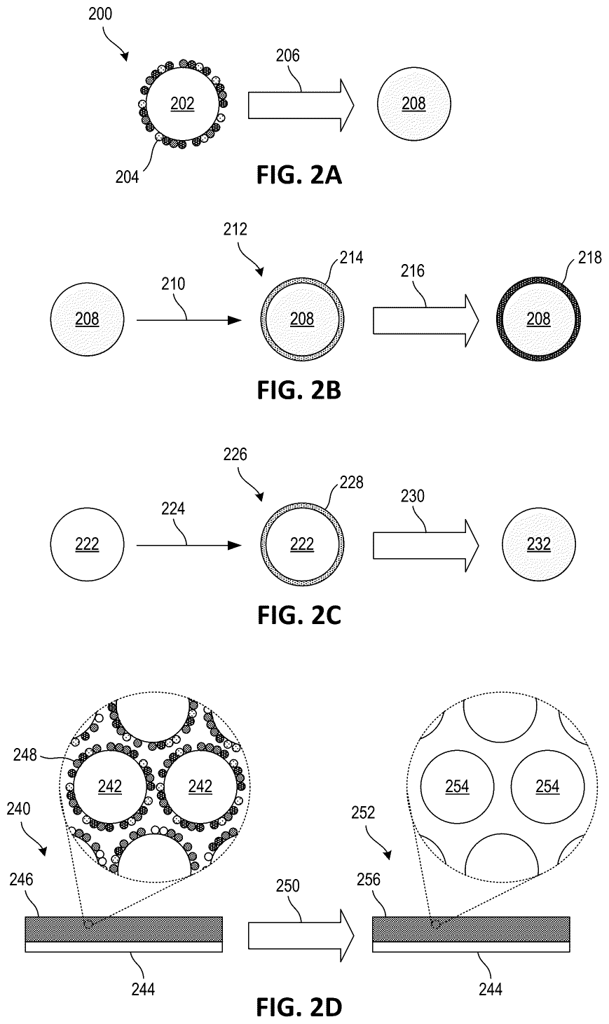

The method 100 can proceed to decision block 104, where the form of the electrode material for subsequent processing can be determined. If processing of electrode material powder is desired at decision block 104, the method 100 can proceed to process block 108, where the electrode material can be separated from full sheet electrode, for example, by scraping the electrode material layer off the metal current collector layer. The method 100 can then proceed to process block 110, where the resulting electrode material powder can be subjected to the thermal shock (e.g., ˜1500 K for ˜100 ms). As shown in FIG. 2A, the degraded electrode material 200 can comprise electrode material particles 202 with impurities 204 thereon. For example, when the electrode material particles 202 are from the negative electrode, the impurities 204 can include isolated metal from the positive electrode (e.g., Li), SEI, residue solvent, and/or binder. In some embodiments, the thermal shock 206 can be effective to remove impurities 204 from the electrode material, for example, via thermal evaporation, thereby forming a regenerated electrode material particle 208. Alternatively or additionally, the thermal shock can improve or enhance the structure of the electrode material, for example, to increase the crystallinity of graphite as compared to the degraded graphite and/or pristine graphite.

Alternatively, if processing of a full sheet electrode (e.g., electrode material layer coupled to metal current collector layer) is desired, the method 100 can proceed to process block 106, where the full sheet electrode can be subjected to the thermal shock (e.g., ˜1200 K for ˜200 ms). As shown in FIG. 2D, a full sheet electrode 240 can include a degraded electrode material layer 246 coupled to a metal current collector layer 244, and the degraded electrode material layer 246 can comprise a plurality of electrode material particles 242 with impurities 248 thereon. For example, when the full sheet electrode 240 is a negative electrode, the impurities 248 can include isolated metal (e.g., Li) from the positive electrode, SEI, residue solvent, and/or binder. In some embodiments, the thermal shock 250 can be effective to remove impurities 248 from the electrode material of the full sheet electrode, for example, via thermal evaporation, thereby forming a regenerated electrode material layer 256. In some embodiments, the thermal shock 250 regenerates the electrode material particles 254 while avoiding, or at least reducing, delamination of the regenerated electrode material layer 256 from and/or deformation of the underlying metal current collector 244, thereby forming a regenerated full sheet electrode 252. Alternatively or additionally, the thermal shock can improve or enhance the structure of the electrode material, for example, to increase the crystallinity of graphite in the electrode material layer as compared to the degraded graphite and/or pristine graphite.

The method 100 can proceed from either process block 106 or process block 110 to decision block 112, where it is determined if further processing is desired. In some embodiments, the further processing can include forming a coating on recycled particles of the electrode material, for example, an amorphous carbon coating on recycled graphite particles. If forming a coating is desired, the method 100 can proceed from decision block 112 to process block 114, where a precursor material is provided on the electrode material. In some embodiments, the precursor material can be coated on the electrode material (e.g., particles), for example, via dip coating, spray coating, electrodeposition, chemical vapor deposition, physical vapor deposition, or any other coating technique. For example, a regenerated electrode material particle 208 (e.g., graphite) can be coated at 210 with a precursor material 214 to form a precursor-coated particle 212, as shown in FIG. 2B. In some embodiments, the precursor material can comprise a polymer (e.g., polyacrylonitrile), a biomass (e.g., cellulose), and/or recycled SEI.

The method 100 can proceed from process block 114 to process block 116, where the precursor-coated electrode material can be subjected to another thermal shock 216 (e.g., ˜1600 K for ˜1 s), for example, to carbonize the precursor material 214 to form an amorphous carbon layer 218 on the electrode material 208, as shown in FIG. 2B. In some embodiments, providing the amorphous carbon layer on graphite particles can facilitate the formation of a uniformly distributed SEI, which can then be dissolved and reformed by switching between an elevated temperature (e.g., ˜45° C.) and a low temperature (e.g., room temperature, such as 20-25° C.). In some embodiments, the time and/or temperature of the another thermal shock of process block 116 can be different than that of the thermal shock of either process block 106 or process block 110.

In some embodiments, the further processing can include replenishing electrode material. If replenishing is desired, the method 100 can proceed from decision block 112 to process block 120, where a metal coating is provided on positive electrode material (e.g., cathode), for example, via dip coating, spray coating, electrodeposition, chemical vapor deposition, physical vapor deposition, or any other coating technique. In some embodiments, the positive electrode material is different than the electrode material processed via either process block 106 or process block 110, for example, negative electrode material (e.g., anode). For example, a degraded positive electrode particle 222 (e.g., spent transition metal oxide, such as LiCoO₂, LiNiO₂, LiMn₂O₄, LiNiₓCo_{y}Mn_{z}O₂ where x+y+2=1 and x, y, z≥0, or LiFePO₄) can be coated at 224 with a metal 228 to form a metal-coated particle 226, as shown in FIG. 2C. In some embodiments, the metal 228 can be the same as that used as the mobile ion in battery operation (e.g., lithium). In some embodiments, the providing of the metal coating of process block 120 can comprise vaporizing or volatilizing metal (e.g., lithium), which then deposits on surfaces of positive electrode material powder. In some embodiments, the metal coating can optionally be provided via recycling of the negative electrode material, for example, via thermal shock of process block 110.

The method 100 can proceed from process block 120 to process block 122, where the metal-coated positive electrode material can be subjected to another thermal shock 230, for example, such that the metal 228 is incorporated into the positive electrode material to form a regenerated positive electrode material 232, as shown in FIG. 2C. In some embodiments, the time and/or temperature of the another thermal shock of process block 122 can be different than that of the thermal shock of either process block 106 or process block 110.

After either of process block 116 or process block 122, or if further processing was not desired at decision block 112, the method 100 can proceed to process block 118, where the recycled electrode material can be used or prepared for use, for example, in or as an electrode in a new battery. For example, when the recycled electrode material is in the form of a full sheet electrode, the recycled electrode material can be assembled with another electrode, electrolyte, and separator to form a battery. Alternatively or additionally, when the recycled electrode material is in the form of a powder, the recycled electrode material can be coupled to a metal current collector layer to form an electrode and then assembled with another electrode, electrolyte, and separator to form a battery.

In some embodiments, the thermal shock of one, some, or all of process blocks 106, 110, 116, and 122 can employ a Joule heating element, for example, similar to any of those disclosed in U.S. Publication No. 2018/0369771, entitled “Nanoparticles and systems and methods for synthesizing nanoparticles through thermal shock,” U.S. Publication No. 2019/0161840, entitled “Thermal shock synthesis of multielement nanoparticles,” International Publication No. WO 2020/236767, entitled “High temperature sintering systems and methods,” or International Publication No. WO 2020/252435, entitled “Systems and methods for high temperature synthesis of single atom dispersions and multi-atom dispersions,” which heating elements are incorporated herein by reference. Alternatively or additionally, in some embodiments, the thermal shock can employ microwave heating, laser heating, electron beam heating, plasma heating, spark discharge heating, or any other heating mechanism capable of providing the thermal shock temperature of at least 1000 K.

Although blocks 102-122 of method 100 have been described as being performed once, in some embodiments, multiple repetitions of a particular process block may be employed before proceeding to the next decision block or process block. In addition, although blocks 102-122 of method 100 have been separately illustrated and described, in some embodiments, process blocks may be combined and performed together (simultaneously or sequentially). Moreover, although FIG. 1A illustrates a particular order for blocks 102-122, embodiments of the disclosed subject matter are not limited thereto. Indeed, in certain embodiments, the blocks may occur in a different order than illustrated or simultaneously with other blocks. In some embodiments, method 100 can include steps or other aspects not specifically illustrated in FIG. 1A. Alternatively or additionally, in some embodiments, method 100 may comprise only some of blocks 102-122 of FIG. 1A.

### Electrode Recycling System Examples

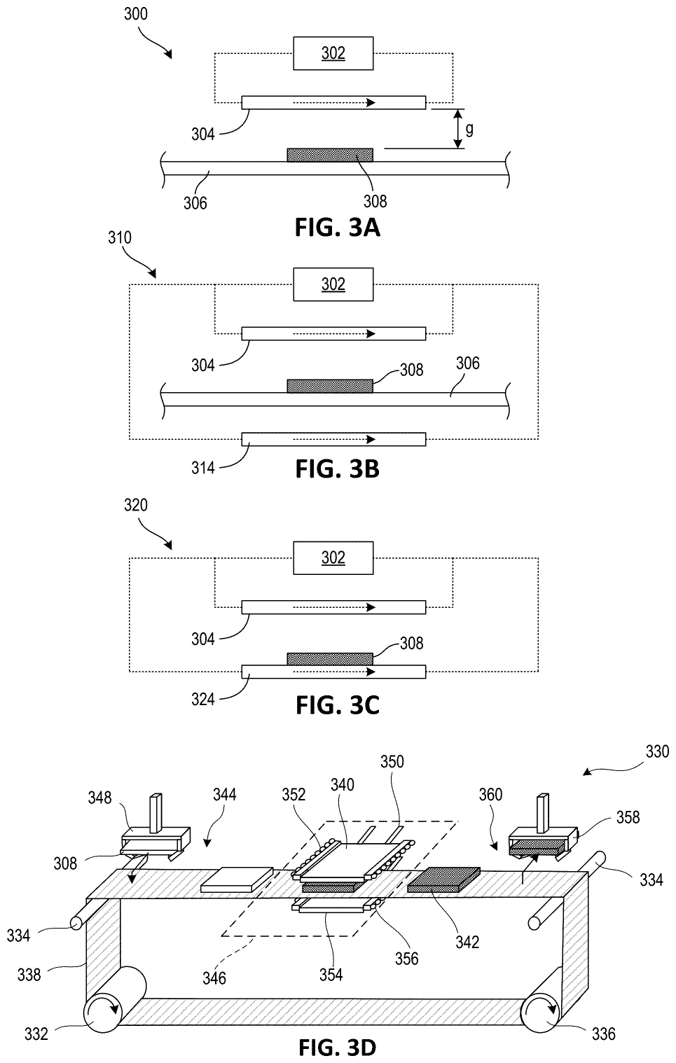

In some embodiments, an electrode material recycling setup 300 can include an electrical power supply 302, a Joule heating element 304, and a support member 306, for example, as shown in FIG. 3A. The degraded electrode material 308 (e.g., full sheet electrode, etc.) can be disposed on the support member 306 and spaced from the Joule heating element 304 by a gap, g, such that the electrode material 308 is heated via radiative heating. In some embodiments, the size of the gap, g, can be less than or equal to 10 mm, for example, less than or equal to 1 mm. Alternatively, the degraded electrode material 308 can be in contact with the Joule heating element 304 (e.g., g=0), such that the electrode material 308 is heated via conductive heating.

In the illustrated example of FIG. 3A, an asymmetric heating configuration is employed. Alternatively, in some embodiments, a symmetric heating configuration can be employed, for example, to provide more uniform heating to the electrode material 308. For example, FIG. 3B illustrates an electrode material recycling setup 310 employing a symmetric heating configuration, in particular, with a first Joule heating element 304 above the electrode material 308 on support member 306 and a second Joule heating element 314 below the electrode material 308. In the illustrated example, the power supply 302 is connected to both heating elements 304, 314 so as to provide respective electrical currents thereto. Alternatively, in some embodiments, each heating element 304, 314 can be connected to its own power supply, or an independently controllable power supply output, for example, such that the heating elements 304, 314 can be operated at different temperatures.

In the illustrated examples of FIG. 3A-3B, the electrode material is provided on a support member 306. In some embodiments, the support member 306 can be formed of carbon or a refractory material. For example, the support member 306 can be a platen, a conveyor belt, a ceramic boat, or any other structure capable of holding the electrode material 308 and withstanding the temperature of the thermal shock. Alternatively, in some embodiments, the electrode material 308 can instead be disposed on and/or in direct contact with one of heating elements. For example, FIG. 3C illustrates an electrode material setup 320 employing a first Joule heating element 304 above and spaced from the electrode material 308, and a second Joule heating element 324 supporting the electrode material 308 thereon. Alternatively or additionally, in some embodiments, the electrode material 308 can be contact with both Joule heating elements 304, 324. In the illustrated example, the power supply 302 is connected to both heating elements 304, 324 so as to provide respective electrical currents thereto. Alternatively, in some embodiments, each heating element 304, 324 can be connected to its own power supply, or an independently controllable power supply output, for example, such that the heating elements 304, 324 can be operated at different temperatures.

In the illustrated examples of FIGS. 3A-3C the duration of the thermal shock is controlled by application of electrical power (e.g., current) to the Joule heating elements 304, 314, 324. Alternatively or additionally, in some embodiments, the duration of the thermal shock can be controlled by movement of the heating element with respect to the electrode material (or portion thereof), movement of the electrode material with respect to the heating element (or portion thereof), or both. For example, the thermal shock can be terminated by conveying the electrode material out of a heating zone (e.g., by moving the electrode material from between the Joule heating elements) and/or by de-activating, de-energizing, or otherwise terminating operation of the heating element(s). Alternatively or additionally, in some embodiments, cooling at the end of a heating period can be achieved using one or more passive cooling features (e.g., heat sinks thermally coupled to the heating element and/or electrode material, etc.), one or more active cooling features (e.g., fluid flow directed at the electrode material and/or heating element, fluid flow through a heat sink thermally coupled thereto, etc.), or any combination thereof.

For example, FIG. 3D shows another configuration of an electrode recycling system 330, for example, employing a continuous conveyor setup. A conveyor film 338 can carry a to-be-recycled electrode material 308 (e.g., a degraded full sheet anode) that is loaded by a feeding mechanism 348 (e.g., a robotic placement unit) to an input zone 344 upstream of a heating zone 346. The conveyor film 338 can be moved by one or more drive rollers 332, 336 and supported by one or more redirection rollers 334, for example, to position the electrode material 308 within heating zone 346 of heating elements 340, 354. In the illustrated example, the conveyor film 338 has a closed loop configuration; however, embodiments of the disclosed subject matter are not limited thereto. Rather, other configurations are also possible according to one or more contemplated embodiments, for example, an open loop configuration employing winding rollers at opposite ends of the conveyor film.

The heating elements 340, 354 can be moved toward (e.g., having a spacing between heating elements≤10 mm) and/or into contact with material 308, for example, via shift guides 350 (e.g., formed of a refractory ceramic, such as carbide). By applying an electrical current to the heating elements 340, 354, for example, via wiring 352, 356 (e.g., formed of a refractory metal, such as tungsten), the material 308 can be rapidly heated via radiation and/or conduction to form a uniform high-temperature environment that removes impurities from the degraded electrode material 308 and/or otherwise regenerates the degraded electrode material 308 into recycled electrode material 342. The recycled electrode material 342 can be removed from the conveyor film 338, for example, at an outlet zone 360 downstream of heating zone 346 using a sample selection mechanism 358 (e.g., a robotic picker unit). Although a single heating zone 346 for processing of a single material 308 at a time is shown in FIG. 3D, embodiments of the disclosed subject matter are not limited thereto. Rather, multiple heating element pairs and corresponding heating zones can be provided for simultaneous batch processing of multiple degraded electrode materials 308.

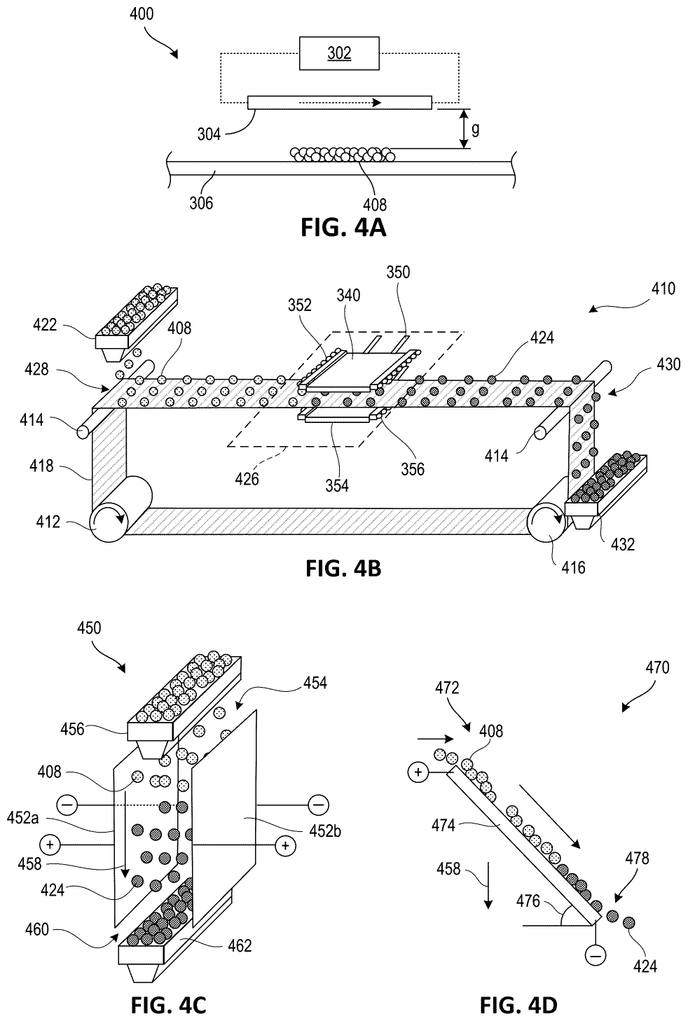

In the illustrated examples of FIGS. 3A-3D, the degraded electrode material 308 is in the form of a solid layer. Alternatively, in some embodiments, the degraded electrode material can be in the form of a powder. For example, FIG. 4A illustrates an electrode material recycling setup 400 for recycling of degraded electrode material powder 408. Similar to the setup 300 of FIG. 3A, the electrode material recycling setup 400 includes electrical power supply 302, Joule heating element 304, and support member 306, as shown in FIG. 4A. The degraded electrode material powder 408 can be disposed on the support member 306 and spaced from the Joule heating element 304 by a gap, g, such that the electrode material powder 408 is heated via radiative heating. In some embodiments, the size of the gap, g, can be less than or equal to 10 mm, for example, less than or equal to 1 mm. Alternatively, at least some of the degraded electrode material powder 408 can be in contact with the Joule heating element 304 (e.g., g=0), such that at least some of the electrode material 408 is heated via conductive heating.

Setups similar to that of FIGS. 3B-3D can also be applied to recycling of degraded electrode material powder. For example, FIG. 4B shows another configuration of an electrode powder recycling system 410, for example, employing a continuous conveyor setup. A conveyor film 418 can carry a to-be-recycled electrode particles 408 (e.g., electrode material powder extracted from a degraded electrode) that is deposited thereon from a particle dispenser 422 to an input zone 428 upstream of a heating zone 426. The conveyor film 418 can be moved by one or more drive rollers 412, 416 and supported by one or more redirection rollers 414, for example, to position the particles 408 within heating zone 426 of heating elements 340, 354. In the illustrated example, the conveyor film 418 has a closed loop configuration; however, embodiments of the disclosed subject matter are not limited thereto. Rather, other configurations are also possible according to one or more contemplated embodiments, for example, an open loop configuration employing winding rollers at opposite ends of the conveyor film.

The heating elements 340, 354 can be moved toward (e.g., having a spacing between heating elements≤10 mm) and/or into contact with particles 408, for example, via shift guides 350 (e.g., formed of a refractory ceramic, such as carbide). By applying an electrical current to the heating elements 340, 354, for example, via wiring 352, 356 (e.g., formed of a refractory metal, such as tungsten), the particles 408 can be rapidly heated via radiation and/or conduction to form a uniform high-temperature environment that removes impurities from the degraded electrode material 308 and/or otherwise regenerates the degraded electrode material 308 into recycled electrode particles 424. The recycled electrode particles 424 can be removed from the conveyor film 418, for example, at an outlet zone 430 downstream of heating zone 426 and collected in a particle collector 432. Alternatively or additionally, in some embodiments, the electrode particles 408 can be integrated with (e.g., pre-deposited on or embedded within) the conveyor film 418 (e.g., in a roll-to-roll setup), in which case particle dispenser 422 and/or collector 432 may be omitted.

In the illustrated example of FIG. 4B, the duration of the thermal shock applied to the electrode particles can be determined by movement of a support member (e.g., conveyor film) with electrode particles thereon through the heating zone. Alternatively, in some embodiments, the electrode particles can move through the heating zone without a separate support member, for example, by employing gravity. For example, FIG. 4C shows a gravity-assisted recycling system 450, in which degraded electrode particles 408 are provided via a particle dispenser 456 to an inlet end 454 of a heating zone between a pair of heating elements 452a, 452b (e.g., arranged substantially parallel to a direction of gravity). In some embodiments, each heating element 452a, 452b can be a piece of carbon paper, carbon felt, or carbon cloth. In some embodiments, the heating elements 452a, 452b can be spaced from each other (e.g., in a direction perpendicular to the direction of gravity 458) by a small distance, for example, ≤10 mm (e.g., ˜3 mm). The particles 408 move under the action of gravity 458 from the inlet end 454 to an outlet end 460 of the heating zone. As the particles 408 pass between the heating elements 452a, 452b, the particles can be subjected to the thermal shock profile to remove impurities and/or upcycle the electrode material, thereby forming recycled electrode particles 424, which can then be collected at particle collector 462. In some embodiments, the size of the heating elements 452a, 452b (e.g., along the direction of gravity 458) can be selected such that a transit time of particles 408 through the heating zone (and thus the duration of the thermal shock) is less than 10 seconds, for example, about 100 ms.

Alternatively, in some embodiments, the electrode particles can move along and in contact with a heating element. For example, FIG. 4D shows a gravity-assisted recycling system 470, in which degraded electrode particles 408 are provided to an inlet end 472 at one end of a sloped heating element 474 (e.g., at an angle with respect to the direction of gravity 458). For example, the heating element 474 can be arranged at an inclination angle 476 with respect to horizontal of about 45°. In some embodiments, the heating element 474 can be a piece of carbon paper, (e.g., thickness of ˜190 μm, length of ˜5 cm, width of ˜2 cm), carbon felt, or carbon cloth.

The particles 408 roll down the sloped heating element 474 under the action of gravity 458 from the inlet end 472 to an outlet end 478. As the particles 408 roll along the heating element 474, the particles can be subjected to the thermal shock profile to remove impurities and/or upcycle the electrode material, thereby forming recycled electrode particles 424. In some embodiments, the size of the heating element 474 (e.g., length from the inlet end 472 to the outlet end 478) and/or the inclination angle 476 can be selected such that a transit time of particles 408 along the heating element 474 (and thus the duration of the thermal shock) is less than 10 seconds, for example, about 100 ms.

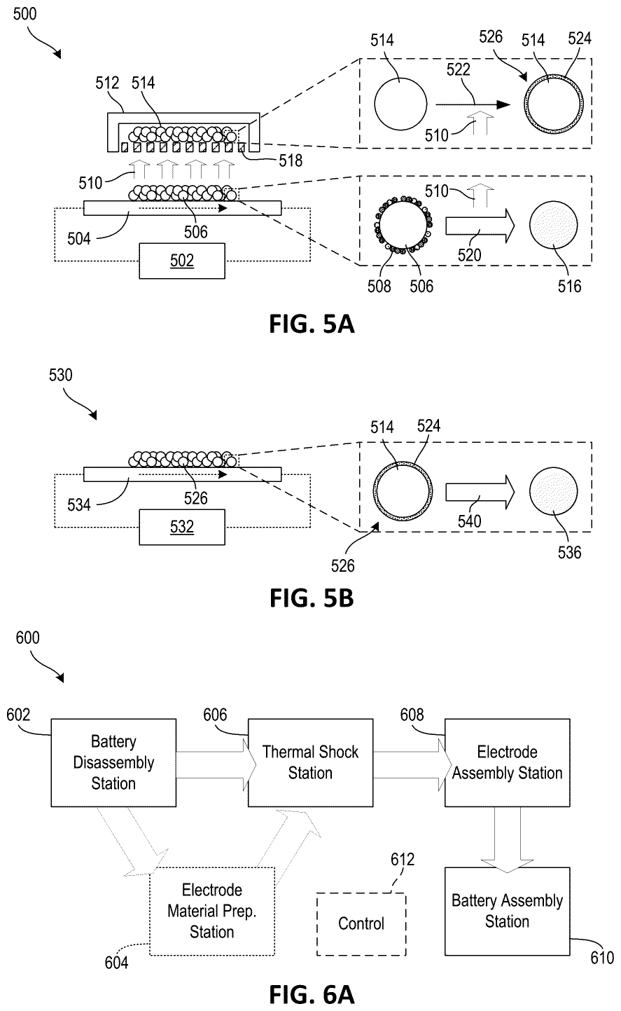

In some embodiments, negative electrode materials can be recycled separately from positive electrode materials. Alternatively, in some embodiments, positive and negative electrode materials from one or more batteries can be recycled together, for example, such that metal impurities (e.g., Li) removed from the degraded negative electrode materials can be used to replenish depleted positive electrode materials. For example, a first stage recycling setup 500 can include a power supply 502, a Joule heating element 504, a shield 512, and a porous sheet 518 (e.g., metal), as shown in FIG. 5A. Degraded negative electrode material 506 can be disposed in thermal communication with the Joule heating element 504, for example, on or spaced therefrom by ≤10 mm. The depleted positive electrode material 514 can be enclosed by the shield 512 and the porous sheet 518, with the porous sheet 518 arranged between the positive electrode material 514 and the negative electrode material 506. Application of a thermal shock 520 to the negative electrode material 506 volatizes metal (e.g., alkali metal) and other impurities 508 on the surface thereof to form a recycled electrode material 516. Meanwhile, the volatized metal 510 resulting from the thermal shock 520 proceeds through the porous sheet 518 and becomes deposited at 522 as a metal coating 524 on positive electrode material 514, thereby forming metal-coated particles 526. To convert the metal-coated particles 526 to regenerate positive electrode material 536, a second thermal shock 540 (e.g., at a temperature greater than the first thermal shock 520) can be applied to allow the metal to be incorporated into the positive electrode material 514 (e.g., oxide lattice structure), as shown in FIG. 5B. For example, the second thermal shock 540 can be applied using a second stage recycling setup 530, which includes a Joule heating element 534 (which can be the same as or different from Joule heating element 504) and a power supply 532 (which can be the same as or different from power supply 502). In this manner, the metal that would otherwise be wasted by recycling degraded negative electrode material 506 can be reused to replenish the depleted positive electrode material 514.

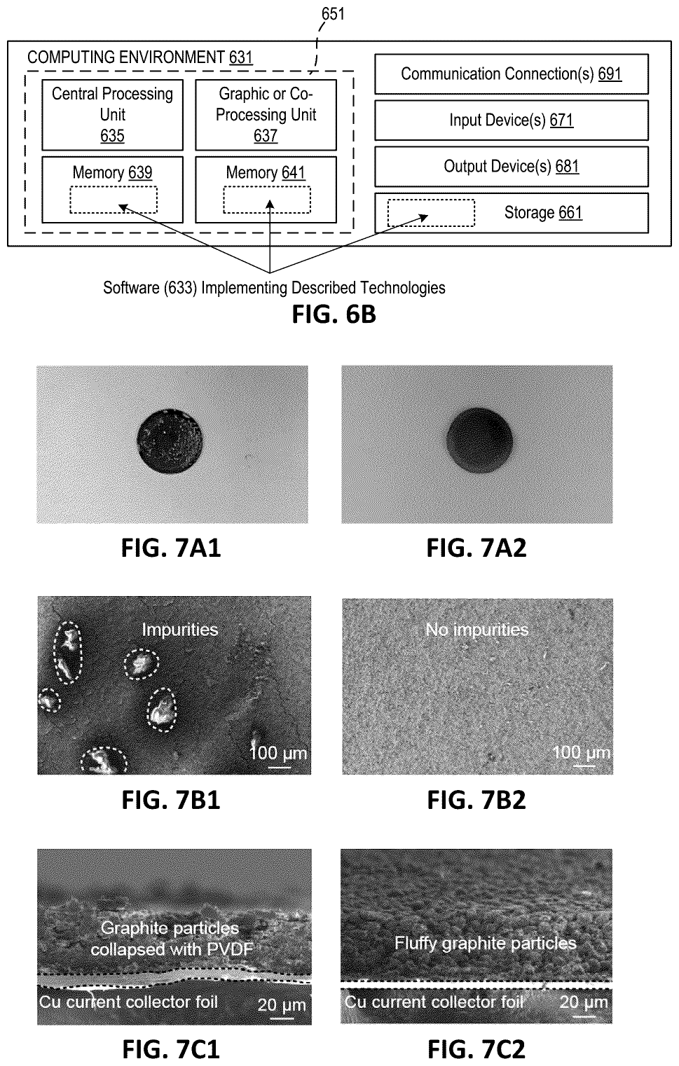

In some embodiments, the recycling of electrode materials via thermal shock can be part of a multi-station battery recycling system, such as system 600 in FIG. 6A. In the illustrated example, the system 600 can include a battery disassembly station 602, a thermal shock station 606, an electrode assembly station 608, and a battery assembly station 610. In some embodiments, the system 600 can optionally include an electrode material preparation station 604 and/or a control system 612. Optional control system 612 can control operation of one or more of stations 602-610, or at least coordinate operations therebetween.

The battery disassembly station 602 can be configured to extract depleted positive electrodes, degraded negative electrodes, or both from used batteries (e.g., lithium ion batteries). In some embodiments, the extracted electrodes can be further processed in optional electrode material preparation station 604, for example, to separate the electrode material layers from respective current collector layers and/or to form the electrode materials as a powder. Alternatively, the extracted electrodes can be maintained as full sheet electrodes for recycling. The thermal shock station 606 can subject the extracted electrode materials (e.g., full sheet from battery disassembly station 602 and/or powder from electrode material preparation station 604) to a thermal shock to regenerate and/or replenish the electrode materials. For example, the thermal shock station 606 can have a configuration similar to one or more of FIGS. 2A-5B. The recycled electrode materials from the thermal shock station 606 can be assembled into new electrodes at electrode assembly station 608, for example, by combining the electrode powder with current collectors to form new full sheet electrodes. The recycled electrodes can then be assembled into new batteries at battery assembly station 610, for example, by assembling with other electrodes, separator, and electrolyte to form a new battery.

### Computer Implementation Examples

FIG. 6B depicts a generalized example of a suitable computing environment 631 in which aspects of the disclosed subject matter may be implemented, such as but not limited to method 100, power supply 302, power supply 502, and/or control system 612. The computing environment 631 is not intended to suggest any limitation as to scope of use or functionality, as the innovations may be implemented in diverse general-purpose or special-purpose computing systems. For example, the computing environment 631 can be any of a variety of computing devices (e.g., desktop computer, laptop computer, server computer, tablet computer, etc.).

With reference to FIG. 6B, the computing environment 631 includes one or more processing units 635, 637 and memory 639, 641. In FIG. 6B, this basic configuration 651 is included within a dashed line. The processing units 635, 637 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 6B shows a central processing unit 635 as well as a graphics processing unit or co-processing unit 637. The tangible memory 639, 641 may be volatile memory (e.g., registers, cache, RAM), non-volatile memory (e.g., ROM, EEPROM, flash memory, etc.), or some combination of the two, accessible by the processing unit(s). The memory 639, 641 stores software 633 implementing one or more innovations described herein, in the form of computer-executable instructions suitable for execution by the processing unit(s).

A computing system may have additional features. For example, the computing environment 631 includes storage 661, one or more input devices 671, one or more output devices 681, and one or more communication connections 691. An interconnection mechanism (not shown) such as a bus, controller, or network interconnects the components of the computing environment 631. Typically, operating system software (not shown) provides an operating environment for other software executing in the computing environment 631, and coordinates activities of the components of the computing environment 631.

The tangible storage 661 may be removable or non-removable, and includes magnetic disks, magnetic tapes or cassettes, CD-ROMs, DVDs, or any other medium which can be used to store information in a non-transitory way, and which can be accessed within the computing environment 631. The storage 661 can store instructions for the software 633 implementing one or more innovations described herein.

The input device(s) 671 may be a touch input device such as a keyboard, mouse, pen, or trackball, a voice input device, a scanning device, or another device that provides input to the computing environment 631. The output device(s) 681 may be a display, printer, speaker, CD-writer, or another device that provides output from computing environment 631.

The communication connection(s) 691 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### FABRICATED EXAMPLES AND EXPERIMENTAL RESULTS

### Example 1: Recycling of Degraded Full Sheet Anode

A degraded anode full sheet electrode composed of graphite particles, a binder of polyvinylidene fluoride (PVDF), and a current collector of copper (Cu) was taken from a lithium ion battery (LIB). As shown in FIG. 7A1, the degraded anode electrode appears to have shining lithium on its surface. SEM imaging revealed that the degraded anode electrode had isolated lithium particles (>100 μm) on its surface, as shown in FIG. 7B1, while the graphite particles have collapsed with the PVDF, as shown in the cross-section of FIG. 7C1. The degraded anode full sheet electrode was subjected to a thermal shock of 1200 K for 200 ms, thereby producing a regenerated full sheet electrode. After thermal shock, no delamination or separation of the graphite flakes from the Cu current collector was observed in the regenerated full sheet electrode, as shown in FIG. 7A2. Moreover, the thermal shock was effective to remove impurities from electrode surface, as shown in FIG. 7B2, while also improving the structure of the graphite particles (e.g., reversing the collapse, so as to be “fluffy”), as shown in FIG. 7C2.

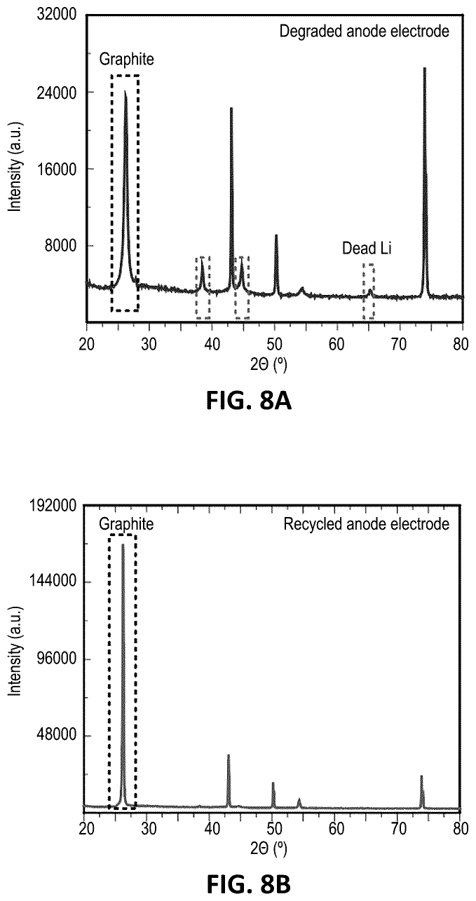

X-ray diffraction (XRD) analysis was performed on both the degraded anode and the regenerated anode. The XRD results of the degraded graphite anode electrode confirmed the existence of Li-containing species with peaks at 2θ of 38.4, 44.7, and 65.3°, as shown in FIG. 8A. In contrast, the peaks of Li-containing species do not appear in the XRD results for the recycled graphite anode electrode, as shown in FIG. 8B. Moreover, the graphite peak in FIG. 8B has become sharper at 2θ of 26.2°, as compared to the peak in FIG. 8A, thereby indicating the efficient upgrading of graphite.

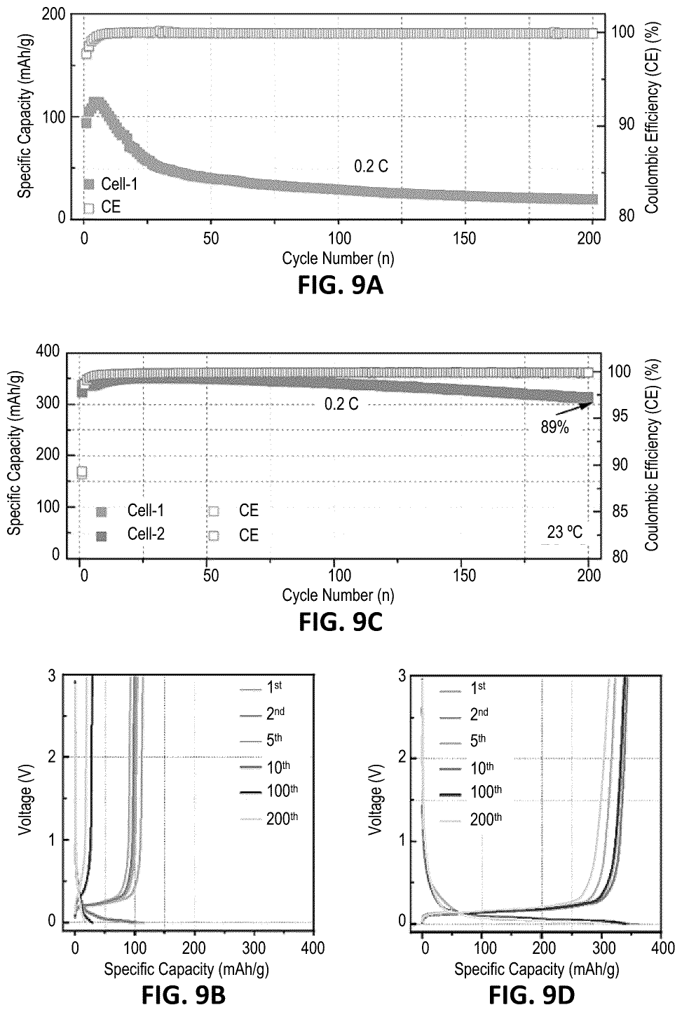

The cycling stability of the recycled graphite (RG) anode electrode was investigated by assembling RG∥Li cells. To allow for a direct comparison, degraded graphite (DG) anode electrodes (without thermal shock) were assembled into DGIILi cells. As shown in FIGS. 9A-9B, the DGIILi cell delivered a low initial reversible capacity of 115 mAh/g at 0.2 C, which rapidly decreased to 40 mAh/g after 50 cycles and further dropped to just 10 mAh/g after 200 cycles. The performance degradation of the DGIILi cell can be attributed to the existence of isolated Li on the graphite surface, which affects intercalation behavior of Li in the graphite layer. As compared to the DGIILi cell, the recycled RG∥Li cell exhibits significantly improved cycling stability. In particular, the initial reversible capacity reaches 340 mAh/g at 0.2 C for the RG∥Li cells, as shown in FIGS. 9C-9D. Moreover, after 160 cycles, the reversible capacity was well maintained at ˜330 mAh/g with 97% capacity retention. Even after 200 cycles, the recycled RG∥Li cell still maintains a reversible capacity of ˜303 mAh/g, with a capacity retention of 89%, as shown in FIG. 9C. These results suggest that the disclosed method employing a thermal shock is capable of successfully recycling a full sheet graphite anode for reuse in a battery (e.g., having a restored battery capacity).

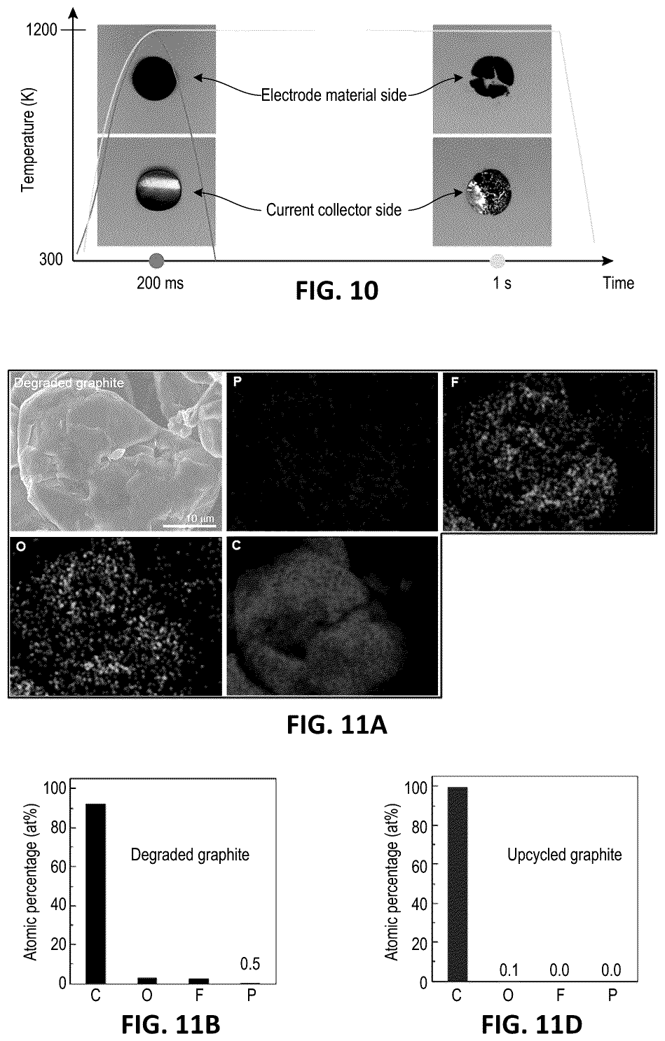

To investigate the effect of thermal shock duration, full sheet graphite anodes were separately subjected to a thermal shock (temperature of 1200 K) for durations of 200 ms and 1 s. As shown in the images on the left of FIG. 10, the integrity of the full sheet graphite anode is maintained after a thermal shock of 200 ms. However, heated at 1200 K for ˜1 s, the copper current collector melted, and the graphite anode broke into pieces, as shown in the images on the right of FIG. 10. However, the temperature and the duration of the thermal shock can be adjusted based on the types of electrode material and impurities, actual or potential damage to the electrode (e.g., melting of current collector, delamination from current collector, etc.), or any other factor or combinations thereof.

### Example 2: Recycling of Degraded Anode Powder

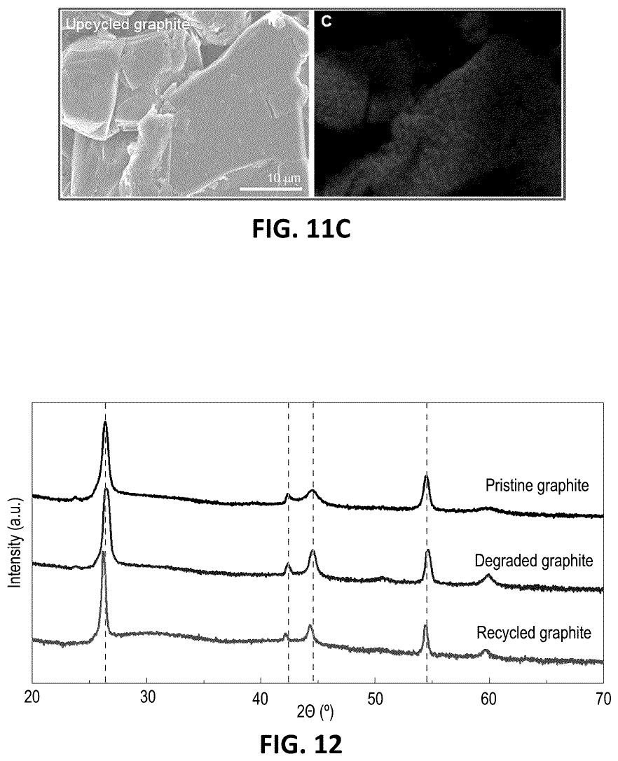

In addition to recycling of a full sheet anode, the disclosed thermal shock method was applied to recycling of anode powder. In particular, degraded graphite powder was upcycled by subjecting to thermal shock to remove impurities such as solid electrolyte interphase (SEI), binder, and solvent. The degraded graphite was collected from failed 18650-type cells. As shown in FIGS. 11A-11B, the degraded graphite contains carbon and impurities, such as SEI, binder, and residual solvent. In particular, the components of electrolyte—the elements of fluorine (F), phosphorus (P), and oxygen (O)—were detectable in the degraded graphite.

The degraded graphite was scraped off the Cu current collector. The degraded graphite was then directly upcycled via thermal shock (e.g., ˜1530 K for a duration of ˜0.1 s, for example, when the heating element exhibits a temperature of ˜ 1970 K) to yield the upcycled graphite. As shown in FIGS. 11C-11D, only the element of carbon (C) is detectable in the upcycled graphite, indicating that the thermal shock is capable of removing the impurities. FIG. 12 displays the XRD of the pristine graphite, degraded graphite, and upcycled graphite. All the samples demonstrate typical peaks of the 2H graphite phase. Note that the (002) diffraction peak (˜26°) of the upcycled graphite shifts to a smaller angle compared to the pristine/degraded graphite, indicating a larger interlayer spacing that can easily adapt to volume expansion during lithiation.

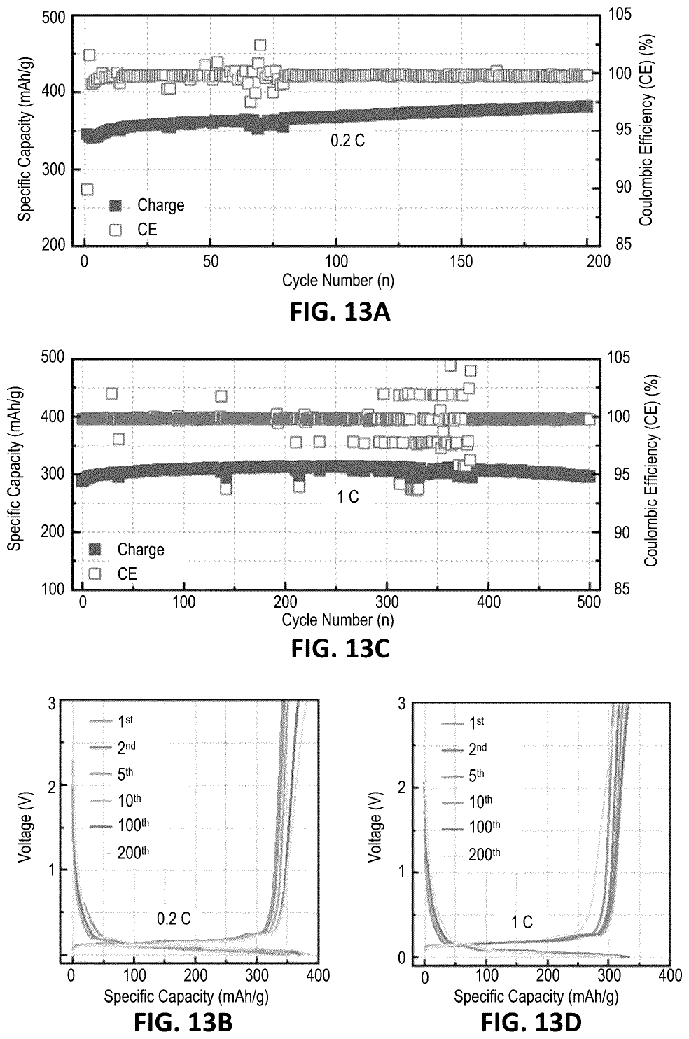

The upcycled graphite (UG) assembled into UG∥Li cells in order to investigate its electrochemical performance. The assembled UG∥Li cells were subjected to long-term cycling tests at different currents. As shown in FIG. 13A, the UG∥Li cell delivered a high initial Coulombic efficiency of 90% at 0.2 C, indicating a new SEI layer formation. After 200 cycles, the UG∥Li maintains a reversible capacity of 350 mAh/g at 0.2 C without capacity fading. The voltage profiles of FIG. 13B show the same lithiation stages as fresh graphite, demonstrating that the disclosed techniques do not destroy the graphite structure. As shown in FIGS. 13C-13D, further cycling at 1 C, the RG∥Li displays a high reversible capacity of 300 mAh/g with a capacity retention of 96% after 500 cycles. These results suggest that rapid high-temperature heating successfully recycled the degraded graphite.

### Example 3: Carbon Coating of Anode Powder

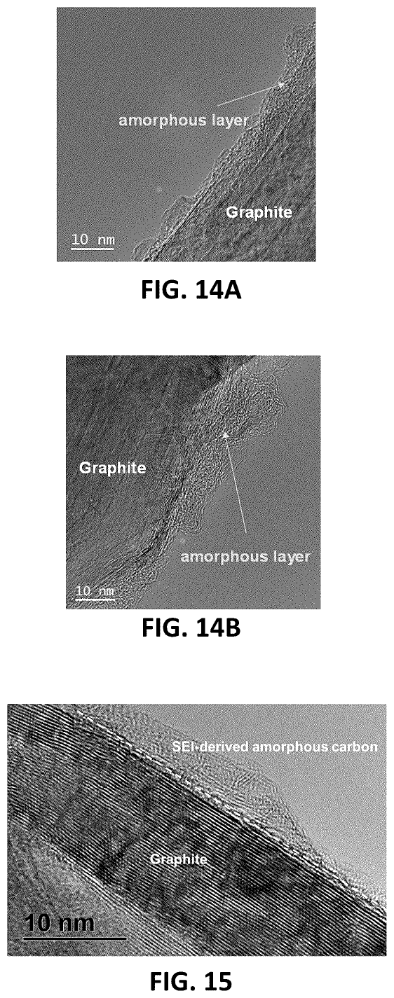

To form a carbon coating, the surface of graphite particles (e.g., pristine graphite or recycled graphite) was covered with a layer of polymer through dip coating. In particular, graphite powder was immersed in a polymer solution (e.g., 0.2-g polyacrylonitrile (PAN) in 20 mL of dimethylformamide (DMF)) and then dried to form a PAN coating on each graphite particle. The PAN-coated graphite particles were subjected to a thermal shock of 1600 K for 1 second (e.g., via Joule heating of a carbon paper, upon which the particles were placed) to carbonize the polymer. FIGS. 14A-14B show transmission electron microscopy (TEM) images of the PAN-coated graphite powder after heating for 1 second at 1600 K and 1800 K, respectively. As shown in FIGS. 14A-14B, the surface of the graphite powder has been covered by an amorphous carbon layer with a thickness of approximately 10 nm. Alternatively, the carbon coating can be formed from a coating of solid electrolyte interphase (SEI) formed on degraded graphite particles. For example, SEI-deposited graphite particles were subjected to a thermal shock of ˜2000K for ˜1 second, resulting in an amorphous carbon layer on the graphite surface, as shown in FIG. 15.

### Example 4: Recycling of Degraded Cathode Powder

A two-stage thermal shock process was used to upcycle spent anode and cathode materials, for example, using the setup of FIGS. 5A-5B. In a first stage, a degraded graphite anode powder was subjected to a first thermal shock, which volatilizes the lithium from the anode powder and deposits the lithium onto the surface of depleted cathode powders of LiFePO₄. In a second stage, the coated cathode powders are regenerated via a second thermal shock, in particular, by allowing the lithium to be incorporated into the oxide structure lattice, thereby forming upcycled cathodes. The upcycled cathode was assembled into a cell, demonstrating a capacity density of approximately 30 mAh/g, with the potential to achieve capacity densities of 170 mAh/g.

### CONCLUSION

Any of the features illustrated or described herein, for example, with respect to FIGS. 1A-15, can be combined with any other feature illustrated or described herein, for example, with respect to FIGS. 1A-15, to provide systems, devices, structures, materials, methods, examples, and embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A method comprising:
subjecting degraded electrode material of a negative electrode from a battery to a first thermal shock, the degraded electrode material having impurities resulting from charge/discharge cycling of the battery,
wherein the first thermal shock comprises a temperature of at least 1000 K for a first time period of 10 seconds or less, a heating rate of at least 10³ K/second preceding the first time period, and a cooling rate of at least 10³ K/second following the first time period, and
the subjecting to the first thermal shock removes at least some impurities from the degraded electrode material so as to form a regenerated electrode material.

2. The method of claim 1, wherein the impurities include isolated metal from a positive electrode of the battery, solid electrolyte interphase, binder, residue solvent, or any combination of the foregoing.

3. The method of claim 2, wherein the isolated metal is an alkali metal.

4. The method of claim 1, wherein the degraded electrode material comprises graphite.

5. The method of claim 1, wherein:
the degraded electrode material is in powder form; and
the method further comprises providing the powder form by separating a layer of the degraded electrode material from a current collector layer of the negative electrode.

6. The method of claim 1, wherein:
the degraded electrode material is a layer of a full sheet electrode; and
the subjecting is such that the layer of degraded electrode material remains attached to a current collector layer of the full sheet electrode.

7. The method of claim 1, wherein a peak temperature during the first time period is at least 1200 K, and the first time period is less than or equal to 500 milliseconds.

8. The method of claim 1, wherein the first time period is set, at least in part, by gravity-assisted movement of the degraded electrode material with respect to one or more heating elements.

9. The method of claim 1, wherein heating to subject the degraded electrode material to the first thermal shock is generated by one or more Joule heating elements.

10. The method of claim 9, wherein the one or more Joule heating elements are formed of or comprise carbon.

11. The method of claim 1, further comprising, after the subjecting to the first thermal shock:
providing one or more precursors on the regenerated electrode material; and
subjecting the regenerated electrode material with one or more precursors to a second thermal shock,
wherein the second thermal shock comprises a temperature for a second time period of 10 seconds or less, and
the subjecting to the second thermal shock converts the one or more precursors to one or more coatings on the regenerated electrode material.

12. The method of claim 11, wherein the temperature of the second thermal shock is greater than the temperature of the first thermal shock.

13. The method of claim 11, wherein the degraded electrode material comprises graphite, the one or more precursors comprise a polymer, and the one or more coatings comprise amorphous carbon.

14. The method of claim 1, wherein:
positive electrode material from a same or different battery faces the degraded electrode material of the negative electrode during the subjecting to the first thermal shock; and
the subjecting to the first thermal shock is such that metal removed from the degraded electrode material is deposited onto the positive electrode material.

15. A method comprising:
providing particles on degraded electrode material of a positive electrode from a battery, the particles comprising a first metal, the degraded electrode material (1) being depleted of the first metal by charge/discharge cycling of the battery, (2) having impurities resulting from the charge/discharge cycling of the battery, or both (1) and (2); and
subjecting the degraded electrode material with particles thereon to a first thermal shock,
wherein the first thermal shock comprises a temperature of at least 1000 K for a first time period of 10 seconds or less, a heating rate of at least 10³ K/second preceding the first time period, and a cooling rate of at least 10³ K/second following the first time period, and
the subjecting to the first thermal shock (a) at least partially replenishes the first metal within the degraded electrode material, (b) removes at least some impurities from the degraded electrode material, or both (a) and (b), so as to form a regenerated electrode material.

16. The method of claim 15, wherein the impurities include solid electrolyte interphase, residue solvent, or any combination of the foregoing.

17. The method of claim 15, wherein:
the degraded electrode material is in powder form; and
the method further comprises providing the powder form by separating a layer of the degraded electrode material from a current collector layer of the positive electrode.

18. The method of claim 15, wherein the degraded electrode material comprises an oxide and the first metal, and the first metal is an alkali metal.

19. The method of claim 15, wherein the degraded electrode material comprises LiCoO₂, LiNiO₂, LiMn₂O₄, LiFePO₄, or LiNiₓCo_{y}Mn_{z}O₂, where x+y+z=1 and x, y, and z are each greater than or equal to 0.

20. The method of claim 15, wherein:
the providing the particles comprises subjecting degraded electrode material of a negative electrode from a same or different battery to a second thermal shock such that the first metal is removed from the degraded electrode material of the negative electrode and is deposited as the particles on the degraded electrode material of the positive electrode; and
the second thermal shock comprises a temperature of at least 1000 K for a second time period of 10 seconds or less.
